(19) United States
(12) Patent Application Publication
(10) Pub. No.: US 2020/0301055 A1
(43) Pub. Date: Sep. 24, 2020

(54) Polarizing Plate and Image Display Device Comprising the Same

(71) Applicant: LG Chem, Ltd., Seoul (KR)

(72) Inventors: Mi So Lee, Daejeon (KR); Yoonkyung Kwon, Daejeon (KR)

(73) Assignee: LG Chem, Ltd., Seoul (KR)

(21) Appl. No.: 16/765,697

(22) PCT Filed: Nov. 23, 2018
(86) PCT No.: PCT/KR2018/014499

§ 371 Date: May 20, 2020

(30) Foreign Application Priority Data
Nov. 24, 2017 (KR) 10-2017-0158709

(51) Int. Cl. G02B 5/30; G02F 1/1335

(52) U.S. Cl. CPC G02B 5/305; G02F 1/133528

(57) ABSTRACT

A polarizing plate and an image display device including the same are provided. The polarizing plate includes a polarizer; and a protective layer in contact with at least one surface of the polarizer. The protective layer is a cured material of a photocurable composition including a photopolymerizable compound; a photoinitiator; a photosensitizer; and an auxiliary photosensitizer. The photopolymerizable compound consists of a first epoxy-based compound, a second epoxy-based compound and an oxetane compound.

### CROSS-REFERENCE TO RELATED APPLICATIONS

The present application is a national stage entry under U.S.C. §371 of International Application No. PCT/KR2018/014499 filed on Nov. 23, 2018, which claims priority to and the benefits of Korean Patent Application No. 10-2017-0158709, filed with the Korean Intellectual Property Office on Nov. 24, 2017, the entire contents of which are incorporated herein by reference in their entirety.

### TECHNICAL FIELD

The present specification relates to a polarizing plate and an image display device comprising the same.

### BACKGROUND ART

Existing polarizing plates for a liquid crystal display device use a general polyvinyl alcohol (PVA)-based polarizer, and have a constitution of attaching a protective film such as polyethylene terephthalate (PET) on at least one side surface of the polarizer.

Recently, demands for low light leakage and thinning of polarizing plates have increased, and in order to satisfy these properties, a method of directly forming a protective layer on a polarizer has been examined instead of using an existing protective base formed as a film in advance.

However, when directly forming a protective layer on an existing polyvinyl alcohol-based elongation-type polyvinyl alcohol-based polarizer, a problem of the polarizer being torn by stress generated from polarizer shrinkage at a high temperature has been difficult to resolve compared to when using a protective substrate on both surfaces as in the art.

### DISCLOSURE

### Technical Problem

The present specification is directed to providing a polarizing plate and an image display device comprising the same.

### Technical Solution

One embodiment of the present specification provides a polarizing plate comprising a polarizer; and a protective layer in contact with at least one surface of the polarizer, wherein the protective layer is a cured material of a photocurable composition for a polarizing plate protective layer comprising a photopolymerizable compound consisting of a first epoxy-based compound, a second epoxy-based compound and an oxetane compound; a photoinitiator; a photosensitizer; and an auxiliary photosensitizer, the protective layer has storage modulus of 1,500 MPa to 10,000 MPa at 80° C., the protective layer has a thickness of 5 μm to 10 μm, and a yellowing scale value (b) of the protective layer measured by the following Equation 1 has an increase rate of 0.05 to 0.3 compared to an initial value (S) under a condition of a temperature of 25° C. and relative humidity (RH) of 40%.

Increase rate of yellowing scale value (b)=yellowing scale value (b) of protective layer coated on polarizer−initial value (S, yellowing scale value (b) of polarizer without protective layer) [Equation 1]

Another embodiment of the present specification provides an image display device comprising the polarizing plate.

### Advantageous Effects

A polarizing plate according to one embodiment of the present specification is capable of replacing an existing base layer required to have an adhesive layer provided in between with one protective layer, and is thereby capable of minimizing costs and processes while thinning and weight lightening the polarizing plate.

A polarizing plate according to one embodiment of the present specification is capable of reducing a yellowing phenomenon that may occur while manufacturing a cation-based protective layer.

A protective layer of a polarizing plate according to one embodiment of the present specification has high storage modulus and is thereby capable of suppressing a shrinkage or expansion phenomenon at a high temperature, and therefore, is capable of preventing tearing of a polarizer and the polarizing plate.

A polarizing plate according to one embodiment of the present specification has an advantage of having high durability even when a separate protective film is not included on a protective layer.

A polarizing plate according to one embodiment of the present specification has an advantage of small or almost no phase difference.

### DESCRIPTION OF DRAWINGS

FIG. 1 illustrates a polarizing plate according to one embodiment of the present specification.

FIG. 2 illustrates a polarizing plate according to another embodiment of the present specification.

FIG. 3 illustrates a polarizing plate according to an additional embodiment of the present specification.

### REFERENCE NUMERAL

10: Polarizer

20: Protective Layer

30: Adhesive Layer

40: Protective Film

### MODE FOR DISCLOSURE

Hereinafter, the present specification will be described in more detail.

In the present specification, a description of a certain part “comprising” certain constituents means capable of further comprising other constituents, and does not exclude other constituents unless particularly stated on the contrary.

In the present specification, a description of a certain member being placed “on” another member comprises not only a case of the one member adjoining the other member but a case of still another member being present between the two members.

When directly forming a protective layer on an existing polyvinyl alcohol-based elongation-type polyvinyl alcohol-based polarizer, a problem of the polarizer being torn by stress generated from polarizer shrinkage at a high temperature has been difficult to resolve compared to when using a protective substrate on both surfaces as in the art. In addition, in order to prevent a problem of optical property decline in a polarizing plate, properties of no phase difference and no yellowing have been required.

Accordingly, in order to directly form a protective layer on a polarizer, properties at a level capable of withstanding stress caused by polarizer shrinkage at a high temperature are required. As the protective layer satisfying such properties, a UV-curable cation-based coating layer is normally used. A cation-based coating layer normally uses a photoinitiator and a photosensitizer to enhance a degree of curing, and in such a process, a problem of optical property decline occurs in a polarizing plate due to yellowing of the cured material.

A polarizing plate according to one embodiment of the present specification is effective in reducing a yellowing phenomenon as well as enhancing high temperature durability by comprising a photosensitizer, a photoinitiator and an auxiliary photosensitizer in a cured material of a photocurable composition for a polarizing plate protective layer, a protective layer, in specific content ranges.

In addition, the protective layer of the polarizing plate according to one embodiment of the present specification has high storage modulus and is thereby capable of suppressing a shrinkage or expansion phenomenon at a high temperature, and therefore, is capable of preventing tearing of a polarizer and the polarizing plate.

In addition, the polarizing plate according to one embodiment of the present specification has an advantage of having high durability even when a separate protective film is not included on a protective layer as well as enhancing high temperature durability by enhancing toughness.

In addition, the polarizing plate according to one embodiment of the present specification has an advantage of having small or almost no phase difference.

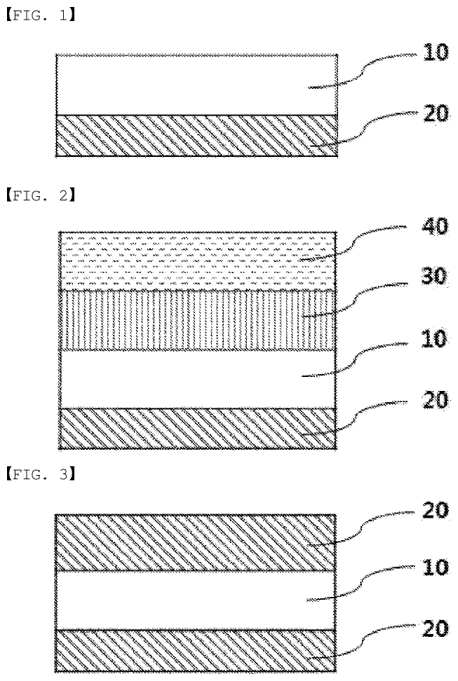

FIG. 1 illustrates a polarizing plate according to one embodiment of the present specification. FIG. 1 illustrates a structure of a polarizing plate in which a protective layer (20) is provided on one surface of a polarizer (10).

In addition, FIG. 3 illustrates a polarizing plate according to still another embodiment of the present specification. FIG. 3 illustrates a structure of a polarizing plate in which a protective layer (20) is provided on both surfaces of a polarizer (10). As in FIG. 3, providing a protective layer on both surfaces of a polarizer has an advantage in that thinning is obtained with almost no phase difference.

One embodiment of the present specification provides a polarizing plate comprising a polarizer; and a protective layer in contact with at least one surface of the polarizer, wherein the protective layer is a cured material of a photocurable composition for a polarizing plate protective layer comprising a photopolymerizable compound consisting of a first epoxy-based compound, a second epoxy-based compound and an oxetane compound; a photoinitiator; a photosensitizer; and an auxiliary photosensitizer, the protective layer has storage modulus of 1,500 MPa to 10,000 MPa at 80° C., the protective layer has a thickness of 5 μm to 10 μm, and a yellowing scale value (b) of the protective layer measured by the following Equation 1 has an increase rate of 0.05 to 0.3 compared to an initial value (S) under a condition of a temperature of 25° C. and relative humidity (RH) of 40%.

Increase rate of yellowing scale value(b)=yellowing scale value (b) of protective layer coated on polarizer−initial value (S, yellowing scale value (b) of polarizer without protective layer) [Equation 1]

In the present specification, as the polarizer, polarizers well known in the art, for example, films formed with polyvinyl alcohol (PVA) comprising iodine or a dichroic dye may be used. The polarizer may be prepared by dyeing a polyvinyl alcohol-based film with iodine or a dichroic dye, however, the preparation method is not particularly limited. In the present specification, the polarizer means a state not comprising a protective layer (or protective film), and the polarizing plate means a state comprising a polarizer and a protective layer (or protective film).

The polarizing plate is prepared through a process of monoaxially elongating a polyvinyl alcohol-based resin film, a process of dyeing the polyvinyl alcohol-based resin film with a dichroic dye and adsorbing the dichroic dye, a process of treating the dichroic dye-adsorbed polyvinyl alcohol-based resin film with an aqueous boric acid solution, a process of washing after the treatment by an aqueous boric acid solution, and a process of bonding a protective layer on the monoaxially elongated polyvinyl alcohol-based resin film to which a dichroic dye is adsorption oriented through these processes.

Monoaxial elongation may be performed before the dyeing by a dichroic dye, may be performed simultaneously with the dyeing by a dichroic dye, or may be performed after the dyeing by a dichroic dye. When monoaxial elongation is preferred after the dyeing by a dichroic dye, this monoaxial elongation may be performed before the boric acid treatment or during the boric acid treatment. In addition, monoaxial elongation may be performed in a plurality of these steps. In order to perform monoaxial elongation, the film may be monoaxially elongated between two rolls having a different moving speed, or may be monoaxially elongated using a heat roll. In addition, the elongation may be dry elongation performing elongation in the air, or may be wet elongation performing elongation while being swollen by a solvent. The elongation ratio is not particularly limited, but is commonly from 4 times to 8 times.

Meanwhile, the polarizer preferably has a thickness of 5 μm to 40 μm and more preferably 5 μm to 25 μm. When the polarizer thickness is smaller than the above-mentioned numerical range, optical properties may decline, and when the thickness of larger than the above-mentioned numerical range, the degree of polarizer shrinkage at a low temperature (for example, −30° C.) increases, which may weaken overall heat-related durability of the polarizing plate.

In addition, when the polarizer is a polyvinyl alcohol-based film, the polyvinyl alcohol-based film is not particularly limited in the use as long as it comprises a polyvinyl alcohol resin or derivatives thereof. Herein, the derivatives of the polyvinyl alcohol resin may comprise, but are not limited to, a polyvinyl formal resin, a polyvinyl acetal resin and the like. In addition, commercially-available polyvinyl alcohol-based films such as P30, PE30 or PE60 of Kuraray Co. Ltd., and M2000, M3000 or M6000 of Nippon Gohsei Co., Ltd. may also be used, however, the polyvinyl alcohol-based film is not limited thereto.

The polyvinyl alcohol-based film preferably has a degree of polymerization of 1,000 to 10,000, and more preferably 1,500 to 5,000. When the degree of polymerization satisfies the above-mentioned numerical range, molecular movements are free, and mixing with iodine, a dichroic dye or the like may be flexible.

The protective layer of the polarizing plate according to one embodiment of the present specification is formed by being directly coated on the polarizer. Being directly coated on the polarizer means the polarizer and the protective layer being physically in contact with each other without providing an adhesive layer in between. In other words, by the protective layer according to one embodiment of the present specification being directly formed on the polarizer without a separate adhesive layer, a thin polarizing plate may be provided. In addition, since the protective layer of the polarizing plate according to one embodiment of the present specification effectively suppresses a shrinkage or expansion phenomenon of the polarizer at a high temperature without a separate protective film, tearing of the polarizer and the polarizing plate may be prevented.

In addition, the protective layer of the polarizing plate according to one embodiment of the present specification is preferably formed with a photocurable composition. When the protective layer is a curable resin layer formed from a photocurable composition as above, there are advantages in that the preparation method is simple, and furthermore, adhesion between the protective layer and the polarizer is excellent. In addition, durability of the polarizing plate may be further improved.

Meanwhile, the photocurable composition for a polarizing plate protective layer according to one embodiment of the present specification preferably has a glass transition temperature of higher than or equal to 90° C. and lower than or equal to 130° C. after curing, and the glass transition temperature may be from 100° C. to 130° C. When having a glass transition temperature as in the above-mentioned numerical range, a protective layer having excellent durability even under a high temperature environment may be obtained.

In the present specification, the glass transition temperature is measured through a dynamic mechanical analysis (DMA) after coating on a release film (for example, polyethylene terephthalate film) to a thickness of 50 μm, curing the result by irradiating ultraviolet rays under a condition of light intensity being 1000 mJ/cm² or greater, then removing the release film, and laser cutting the specimen to a certain size. Herein, the glass transition temperature is identified through inflection of storage modulus when constantly tensioning with 10% strain while, as the measurement temperature, raising the temperature up to 160° C. from a starting temperature of −10° C. at a temperature raising rate of 5° C./min.

According to one embodiment of the present specification, the photocurable composition for a polarizing plate protective layer may further comprise one or more of a dye, a pigment, an epoxy resin, an ultraviolet stabilizer, an antioxidant, a colorant, a reinforcing agent, a filler, a defoamer, a surfactant and a plasticizer as necessary.

Meanwhile, a method for forming the protective layer is not particularly limited, and the protective layer may be formed using methods well known in the art. For example, the protective layer may be formed using a method of forming a barrier layer through coating the photocurable composition for a polarizing plate protective layer on at least one surface of the polarizer using a coating method well known in the art such as a method of spin coating, bar coating, roll coating, gravure coating or blade coating, and then irradiating ultraviolet rays, which is irradiation light, using an ultraviolet irradiator.

Alternatively, the protective layer may also be formed by coating the photocurable composition for a polarizing plate protective layer on at least one surface of the polarizer, and then curing the result using an ultraviolet irradiator, however, the method is not limited thereto.

The ultraviolet wavelength is preferably from 100 nm to 400 nm and more preferably from 320 nm to 400 nm. In addition, the light intensity of the irradiation light is preferably from 100 mJ/cm² to 1000 mJ/cm² and more preferably from 500 mJ/cm² to 1000 mJ/cm².

The irradiation time of the irradiation light is preferably from 1 second to 10 minutes and more preferably from seconds to 30 seconds. Satisfying the above-mentioned irradiation time range has an advantage of minimizing running wrinkle occurrences on the polarizer by preventing the excessive transfer of heat from a light source.

In one embodiment of the present specification, the protective layer preferably has storage modulus of 1,500 MPa to 10,000 MPa, more preferably 1,800 MPa to 5,000 MPa and most preferably 2,000 MPa to 3,500 MPa at 80° C.

When storage modulus of the protective layer satisfies the above-mentioned numerical range, stress applied to the polarizer is effectively suppressed, which is effective in effectively suppressing crack occurrences on the polarizer caused by polarizer shrinkage or expansion under a high temperature or high humidity environment. In addition, adhesive strength for the polarizer is enhanced. As a result, by suppressing shrinkage and expansion of the polarizing plate at a high temperature, occurrences of light leakage may be prevented as well as obtaining excellent adhesive strength when using the polarizing plate in a liquid crystal panel and the like.

In one embodiment of the present specification, the protective layer may effectively prevent an increase in the yellowing scale of the polarizer by comprising specific types of a photoinitiator, a photosensitizer and an auxiliary photosensitizer in the photocurable composition for a protective layer.

In one embodiment of the present specification, the yellowing scale value (b) of the protective layer preferably has an increase rate of 0.05 to 0.3 and more preferably 0.05 to 0.15 compared to an initial value (S) under a condition of 25° C. and relative humidity (RH) of 40%. When the increase rate of the yellowing scale value (b) of the protective layer satisfies the above-mentioned numerical range, optical properties of the polarizing plate do not decline.

In the present specification, the initial value (S) means a measurement value of the polarizer itself without the protective layer. In other words, the initial value (S) in the present specification is obtained by measuring a yellowing scale value (b) of the polarizer itself as a reference under a condition of a temperature of 25° C. and relative humidity (RH) of 40%. The yellowing scale value (b) may be measured using a spectrophotometer (V-7100, manufactured by JASCO International Co., Ltd.), however, the measurement is not limited thereto. In the present specification, the increase rate of the yellowing scale value (b) means, compared to the initial value (S) that is a measurement value of the polarizer itself without the protective layer, a difference with a value measured after laminating the protective layer on the polarizer, curing the result, and after 1 day so that a sufficient dark reaction progresses.

Increase rate of yellowing scale value (b)=yellowing scale value (b) of protective layer coated on polarizer−initial value (S, yellowing scale value (b) of polarizer without protective layer) [Equation 1]

In order not to inhibit optical properties of the polarizing plate, it is important not to decline optical properties of the polarizer even after laminating the protective layer as above. Specifically, the protective layer laminated on the polarizer normally performs a role of protecting cracks or discoloration of the polarizer from an external environment of high temperature and high humidity, and a photoinitiator and a photosensitizer added thereto for this cause a problem of yellowing the cured material of the protective layer composition. Accordingly, properties that do not change optical properties of the polarizer while effectively protecting the polarizer from an external environment are required. In the polarizing plate according to one embodiment of the present specification, the yellowing scale value (b) has an increase rate of just 0.05 to 0.3 compared to the initial value (S). In other words, the increase rate of the yellowing scale value (b) is not high even after laminating the protective layer on the polarizer, which means very effective in not inhibiting optical properties of the polarizer.

In one embodiment of the present specification, the protective layer preferably has a thickness of 5 μm to 10 μm and more preferably 6 μm to 8 μm.

The thickness of the protective layer being less than the above-mentioned range may cause concern of decreasing protective layer strength or high temperature durability, and the thickness being greater than the above-mentioned range is not proper in terms of thinning of the polarizing plate.

In one embodiment of the present specification, the first epoxy-based compound is an alicyclic epoxy-based compound.

Specifically, the alicyclic epoxy-based compound means an epoxy-based compound in which an epoxy group is formed between two adjacent carbon atoms forming an aliphatic hydrocarbon ring. Examples thereof may comprise 2-(3,4-epoxy)cyclohexyl-5,5-spiro-(3,4-epoxy)cyclohexane-m-dioxane, 3,4-epoxycyclohexylmethyl-3, 4-epoxycyclohexane carboxylate, 3,4-epoxy-6-methylcyclohexylmethyl-3,4-epoxy-6-methylcyclohexane carboxylate, vinylcyclohexane dioxide, bis(3,4-epoxycyclohexylmethyl)adipate, bis(3,4-epoxy-6-methylcyclohexylmethyl)adipate, exo-exo bis(2,3-epoxycyclopentyl)ether, endo-exo bis(2,3-epoxycyclopentyl)ether, 2,2-bis[4-(2,3-epoxypropoxy) cyclohexyl]propane, 2,6-bis(2,3-epoxypropoxycyclohexyl-p-dioxane), 2,6-bis(2,3-epoxypropoxy)norbornene, limonene dioxide, 2,2-bis(3,4-epoxycyclohexyl)propane, dicyclopentadiene dioxide, 1,2-epoxy-6-(2,3-epoxypropoxy)hexahydro-4,7-methanoindane, p-(2,3-epoxy)cyclopentylphenyl-2,3-epoxypropyl ether, 1-(2,3-epoxypropoxy)phenyl-5,6-epoxyhexahydro-4,7-methanoindane, o-(2,3-epoxy)cyclopentylphenyl-2,3-epoxypropyl ether, 1,2-bis[5-(1,2-epoxy)-4,7-hexahydromethanoindanoxyl]ethanecyclopentenyl phenyl glycidyl ether, methylenebis(3,4-epoxycyclohexane)ethylene glycol di(3,4-epoxycyclohexylmethyl) ether, ethylenebis(3,4-epoxycyclohexane carboxylate), ε-caprolactone adducts of 3,4-epoxycyclohexane methanol, ester compounds of multivalent (3 to 20) alcohols, and the like, and particularly, 3,4-epoxycyclohexylmethyl-3,4-epoxycyclohexane carboxylate is preferred, however, the alicyclic epoxy-based compound is not limited thereto.

In one embodiment of the present specification, the first epoxy-based compound is preferably included in 50 parts by weight to 70 parts by weight with respect to a total 100 parts by weight of the photopolymerizable compound.

When comprising the first epoxy-based compound in the above-mentioned numerical content range, the composition may be effectively cured during photocuring, and high glass transition temperature and storage modulus may be maintained after the curing resulting in an advantage of excellent durability.

In one embodiment of the present specification, the second epoxy-based compound is an aliphatic epoxy-based compound.

Specifically, the aliphatic epoxy-based compound means an epoxy-based compound comprising an aliphatic chain or an aliphatic ring in the molecule. Examples thereof may comprise 1,4-cyclohexane dimethanol diglycidyl ether, 1,4-butanediol diglycidyl ether, 1,6-hexanediol diglycidyl ether, neopentyl diglycidyl ether, resorcinol diglycidyl ether, diethylene glycol diglycidyl ether, ethylene glycol diglycidyl ether, trimethylol propane triglycidyl ether, n-butyl glycidyl ether, 2-ethylhexyl glycidyl ether and the like, and particularly, using 1,4-cyclohexane dimethanol diglycidyl ether and neopentyl diglycidyl ether is preferred, however, the aliphatic epoxy-based compound is not limited thereto. In addition, the second epoxy-based compound may be one, or two or more types of compounds selected from among the aliphatic epoxy-based compounds.

In one embodiment of the present specification, the second epoxy-based compound is preferably included in 10 parts by weight to 20 parts by weight with respect to a total 100 parts by weight of the photopolymerizable compound.

When comprising the second epoxy-based compound in the above-mentioned numerical content range, the composition may be effectively cured during photocuring, and high glass transition temperature and storage modulus may be maintained after the curing resulting in an advantage of excellent durability.

In one embodiment of the present specification, types of the oxetane compound are not particularly limited, and oxetane compounds known in the art may be used. Examples thereof may comprise 3-ethyl-3-[(3-ethyloxetan-3-yl)methoxymethyl]oxetane, 1,4-bis[(3-ethyloxetan-3-yl)methoxymethyl]benzene, 1,4-bis[(3-ethyloxetan-3-yl)methoxy]benzene, 1,3-bis[(3-ethyloxetan-3-yl)methoxy]benzene, 1,2-bis[(3-ethyloxetan-3-yl)methoxy]benzene, 4,4′-bis[(3-ethyloxetan-3-yl)methoxy]biphenyl, 2,2′-bis[(3-ethyloxetan-3-yl)methoxy]biphenyl, 3,3′,5,5′-tetramethyl-4,4′-bis[(3-ethyloxetan-3-yl)methoxy]biphenyl, 2,7-bis[(3-ethyloxetan-3-yl)methoxy]naphthalene, bis[4-{(3-ethyloxetan-3-yl)methoxy}phenyl]methane, bis[2-{(3-ethyloxetan-3-yl)methoxy}phenyl]methane, 2,2-bis[4-{(3-ethyloxetan-3-yl)methoxy}phenyl]propane, an etherified denatured product of a novolac-type phenol-formaldehyde resin by 3-chloromethyl-3-ethyloxetane, 3(4),8(9)-bis[(3-ethyloxetan-3-yl)methoxymethyl]-tricyclo[5.2.1.0 2,6]decane, 2,3-bis[(3-ethyloxetan-3-yl)methoxymethyl]norbornane, 1,1,1-tris[(3-ethyloxetan-3-yl)methoxymethyl]propane, 1-butoxy-2,2-bis[(3-ethyloxetan-3-yl)methoxymethyl]butane, 1,2-bis[{2-(3-ethyloxetan-3-yl)methoxy}ethylthio]ethane, bis[{4-(3-ethyloxetan-3-yl)methylthio}phenyl] sulfide, 1,6-bis[(3-ethyloxetan-3-yl)methoxy]-2,2,3,3,4,4,5,5-octafluorohexane and the like, but are not limited thereto.

In one embodiment of the present specification, the oxetane compound is preferably included in 10 parts by weight to 30 parts by weight and more preferably included in 20 parts by weight to 30 parts by weight with respect to a total 100 parts by weight of the photopolymerizable compound.

The oxetane compound being included in the above-mentioned numerical content range has an advantage of maintaining high glass transition temperature and storage modulus after curing the photocurable composition. In addition, a protective layer having a uniform thickness may be formed by maintaining constant viscosity.

In one embodiment of the present specification, the photoinitiator is an iodine-based compound absorbing a wavelength of 310 nm or lower. Specifically, the photoinitiator means an iodine-based compound activated by absorbing a wavelength of 310 nm or lower, and generating cations or Lewis acids by irradiating active energy. Examples thereof may comprise diphenyl iodonium hexafluorophosphate (Iod-PF6), diphenyl iodonium triflate (Iod-OSO₂CF₃), diphenyl iodonium p-toluene sulfonate (Iod-OSO₂PhCH₃), diphenyl iodonium chloride (Iod-Cl), [4-methylphenyl-(4-(2-methylpropyl)phenyl)] iodonium hexafluorophosphate (Irgacure 250) and the like, and [4-methylphenyl-(4-(2-methylpropyl)phenyl)] iodonium hexafluorophosphate (Irgacure 250) is preferred, however, the photoinitiator is not limited thereto.

In one embodiment of the present specification, the photoinitiator is preferably included in 2 parts by weight to 5 parts by weight and more preferably included in 2.5 parts by weight to 3.5 parts by weight with respect to a total 100 parts by weight of the photocurable composition for a polarizing plate protective layer.

When the photoinitiator is included in the above-mentioned numerical content range, ultraviolet rays may effectively reach inside the protective layer, the polarization rate is also excellent, and the produced polymer may be prevented from its molecular weight being reduced. Accordingly, advantages of excellent cohesion of the formed protective layer and excellent adhesive strength for the polarizer are obtained.

In one embodiment of the present specification, the photosensitizer is an anthracene-based compound absorbing a wavelength of 380 nm or higher.

In one embodiment of the present specification, the photosensitizer is a compound represented by the following Chemical Formula 1.

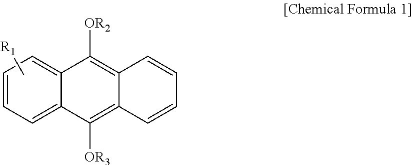

In Chemical Formula 1,

R₁ is the same as or different from each other, and each independently hydrogen; or an alkyl group having 1 to 6 carbon atoms,

R₂ and R₃ are the same as or different from each other, and each independently an alkyl group having 1 to 6 carbon atoms; or an alkoxyalkyl group having 2 to 12 carbon atoms.

In one embodiment of the present specification, examples of the photosensitizer may comprise 9,10-dimethoxyanthracene, 9,10-diethoxyanthracene, 9,10-dipropoxyanthracene, 9,10-diisopropoxyanthracene, 9,10-dibutoxyanthracene, 9,10-dipentyloxyanthracene, 9,10-dihexyloxyanthracene, 9,10-bis(2-methoxyethoxy)anthracene, 9,10-bis(2-ethoxyethoxy)anthracene, 9,10-bis(2-butoxyethoxy)anthracene, 9, 10-bis (3-butoxypropoxy) anthracene, 2-methyl or 2-ethyl-9,10-dimethoxyanthracene, 2-methyl or 2-ethyl-9,10-diethoxyanthracene, 2-methyl or 2-ethyl-9,10-dipropoxyanthracene, 2-methyl or 2-ethyl-9,10-diisopropoxyanthracene, 2-methyl or 2-ethyl-9,10-dibutoxyanthracene, 2-methyl or 2-ethyl-9,10-dipentyloxyanthracene, 2-methyl or 2-ethyl-9,10-dihexyloxyanthracene and the like.

In one embodiment of the present specification, the photosensitizer is preferably included in 0.1 parts by weight to 0.5 parts by weight and more preferably included in 0.15 parts by weight to 0.3 parts by weight with respect to a total 100 parts by weight of the photocurable composition for a polarizing plate protective layer.

The photosensitizer being included in the above-mentioned numerical content range helps with efficient initiation of the photoinitiator of 310 nm or lower by receiving ultraviolet rays of 380 nm or higher, the polarization rate is excellent due to effective curing to the inside of the protective layer, and the produced polymer may be prevented from its molecular weight being reduced. In addition, the content being greater than the above-mentioned numerical range causes yellowing of the protective layer declining optical properties of the polarizer.

In one embodiment of the present specification, the auxiliary photosensitizer is a naphthalene-based compound.

In one embodiment of the present specification, the auxiliary photosensitizer is a compound represented by the following Chemical Formula 2.

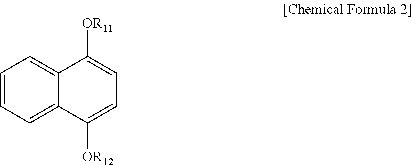

In Chemical Formula 2,

R₁₁ and R₁₂ are the same as or different from each other, and each independently an alkyl group having 1 to 6 carbon atoms.

In one embodiment of the present specification, examples of the auxiliary photosensitizer may comprise 1,4-dimethoxynaphthalene, 1-ethoxy-4-methoxynaphthalene, 1,4-diethoxynaphthalene, 1,4-dipropoxynaphthalene, 1,4-dibutoxynaphthalene and the like.

In one embodiment of the present specification, the auxiliary photosensitizer is preferably included in 1 parts by weight to 3 parts by weight and more preferably in 1 parts by weight to 2 parts by weight with respect to a total 100 parts by weight of the photocurable composition for a polarizing plate protective layer.

The auxiliary photosensitizer being included in the above-mentioned numerical content range helps with efficient initiation of the photoinitiator by excitation of the photosensitizer. Specifically, the anthracene-based photosensitizer excited by receiving ultraviolet rays of 380 nm or higher instantly transfers energy to the auxiliary photosensitizer, and the auxiliary photosensitizer excited as above transfers energy so as to efficiently initiate the photoinitiator. As a result, the ultraviolet rays may effectively reach inside the protective layer, the polarization rate is also excellent, and the produced polymer may be prevented from its molecular weight being reduced. Accordingly, advantages of excellent cohesion of the formed protective layer and excellent adhesive strength for the polarizer are obtained.

In one embodiment of the present specification, the photocurable composition for a polarizing plate protective layer preferably has viscosity of greater than or equal to 50 cps and less than or equal to 200 cps and more preferably greater than or equal to 50 cps and less than or equal to 130 cps at 25° C.

When the viscosity of the photocurable composition for a polarizing plate protective layer satisfies the above-mentioned numerical range, the protective layer may be formed to be thin, and an advantage of excellent workability is obtained.

In one embodiment of the present specification, the protective layer preferably has storage modulus of 1,500 MPa to 10,000 MPa, more preferably 1,800 MPa to 8,000 MPa and most preferably 2,000 MPa to 7,000 MPa at 80° C.

When storage modulus of the protective layer satisfies the above-mentioned numerical range, stress applied to the polarizer is effectively suppressed, which is effective in effectively suppressing crack occurrences on the polarizer caused by polarizer shrinkage or expansion under a high temperature or high humidity environment. In addition, adhesive strength for the polarizer is enhanced. As a result, by suppressing shrinkage and expansion of the polarizing plate at a high temperature, occurrences of light leakage may be prevented as well as obtaining excellent adhesive strength when using the polarizing plate in a liquid crystal panel and the like.

One embodiment of the present specification provides a polarizing plate having a protective film attached on a surface opposite to the surface in contact with the protective layer of the polarizer using an adhesive layer as a medium.

Specifically, when the protective layer is formed on one surface of the polarizer in the polarizing plate according to one embodiment of the present specification, a separate transparent protective film may be attached on a surface opposite to the protective layer-formed surface using an adhesive layer as a medium in order to support and protect the polarizer.

Herein, the protective film is for supporting and protecting the polarizer, and protective films made of various materials generally known in the art such as a polyethylene terephthalate (PET) film, a cycloolefin polymer (COP) film, or an acryl-based film such as tri-acetyl cellulose (TAC) may be used. Considering optical properties, durability, economic feasibility and the like, using a polyethylene terephthalate film is particularly preferred among these.

Meanwhile, attaching the polarizer and the protective film may be carried out using a method of, after coating an adhesive composition for a polarizing plate on the surface of the polarizer or the protective film using a roll coater, a gravure coater, a bar coater, a knife coater, a capillary coater or the like, heating and laminating these using a laminating roll, laminating through room temperature pressing, irradiating UV after lamination, or the like.

FIG. 2 illustrates a polarizing plate according to another embodiment of the present specification. In FIG. 2, a structure of a polarizing plate in which a protective layer (20) is provided on one surface of a polarizer (10), an adhesive layer (30) is provided on a surface opposite to the surface in contact with the protective layer of the polarizer, and a protective film (40) is provided on the adhesive layer is illustrated.

In one embodiment of the present specification, the adhesive layer is a cured material of an adhesive composition, and the adhesive composition comprises an epoxy compound and an oxetane compound.

The adhesive layer is preferably formed with a photocurable adhesive composition. A curable resin layer in which the adhesive layer is formed with a photocurable composition as above has advantages in that the preparation method is simple, and furthermore, adhesion with the protective film is excellent. In addition, durability of the polarizing plate may be further improved.

As the epoxy compound, at least one or more of an alicyclic epoxy compound and a glycidyl ether-type epoxy compound may be used, and preferably, a mixture of an alicyclic epoxy compound and a glycidyl ether-type epoxy compound may also be used. The glycidyl ether-type epoxy compound means an epoxy compound comprising at least one or more glycidyl ether groups.

Examples of the epoxy compound may comprise 3,4-epoxycyclohexylmethyl-3,4-epoxycyclohexane carboxylate, bis(3,4-epoxycyclohexylmethyl)adipate, a caprolactone-modified compound of 3,4-epoxycyclohexylmethyl-3,4-epoxycyclohexane carboxylate, an ester compound or caprolactone-modified compound of polyvalent carboxylic acid and 3,4-epoxycyclohexylmethyl alcohol, a silicone-based compound having an alicyclic epoxy group at the end, diglycidyl ether of bisphenol A, diglycidyl ether of bisphenol F, diglycidyl ether of brominated bisphenol A, a phenol novolac-type epoxy resin, a cresol novolac-type epoxy resin, a biphenyl-type epoxy resin, terephthalic acid diglycidyl ester, phthalic acid diglycidyl ester, an addition reactant of end carboxylic acid polybutadiene and a bisphenol A-type epoxy resin, dicyclopentadiene dioxide, limonene dioxide, 4-vinylcyclohexene dioxide, polyethylene glycol diglycidyl ether, polypropylene glycol diglycidyl ether, polytetramethylene glycol diglycidyl ether, hydrogen-added bisphenol A diglycidyl ether, epoxylated vegetable oil, 2-(3,4-epoxycyclohexyl)ethyltrimethoxysilane, 2-(3,4-epoxycyclohexyl)ethyltriethoxysilane, 3-glycidoxypropyltrimethoxysilane, 3-glycidoxypropylmethyldimethoxysilane, polybutadiene diglycidyl ether of both end hydroxyl groups, an inner epoxide of polybutadiene, a compound in which double bonds of a styrene-butadiene copolymer are partly epoxylated (for example “Epofriend” manufactured by Daicel Corporation), a compound in which isoprene units of a block copolymer of an ethylene-butylene copolymer and polyisoprene are partly epoxylated (for example, “L-207” manufactured by KRATON Corporation) and the like, but are not limited thereto.

Examples of the glycidyl ether-type epoxy compound may comprise novolac epoxy, bisphenol A-based epoxy, bisphenol F-based epoxy, brominated bisphenol epoxy, n-butyl glycidyl ether, aliphatic glycidyl ether (12 to 14 carbon atoms), 2-ethylhexyl glycidyl ether, phenyl glycidyl ether, o-cresyl glycidyl ether, nonylphenyl glycidyl ether, ethylene glycol diglycidyl ether, diethylene glycol diglycidyl ether, propylene glycol diglycidyl ether, tripropylene glycol diglycidyl ether, neopentyl glycol diglycidyl ether, 1,4-butanediol diglycidyl ether, 1,6-hexanediol diglycidyl ether, trimethylolpropane triglycidyl ether, trimethylolpropane diglycidyl ether, trimethylolpropane polyglycidyl ether, polyethylene glycol diglycidyl ether or glycerin triglycidyl ether and the like. In addition, glycidyl ether having a ring-type aliphatic skeleton such as 1,4-cyclohexanedimethanol diglycidyl ether, a hydrogen-added compound of an aromatic epoxy compound and the like may be included as an example. Preferably, glycidyl ether having a ring-type aliphatic skeleton, and glycidyl ether having a ring-type aliphatic skeleton with preferably 3 to 20 carbon atoms, preferably 3 to 16 carbon atoms, and more preferably 3 to 12 carbon atoms may be used, however, the glycidyl ether-type epoxy compound is not limited thereto.

Meanwhile, when the alicyclic epoxy compound and the glycidyl ether-type epoxy compound are mixed, the weight ratio is preferably from 1:1 to 1:0.5.

According to one embodiment of the present specification, the alicyclic epoxy compound is preferably included in 30 parts by weight to 80 parts by weight and more preferably in 50 parts by weight to 70 parts by weight based on a total weight of the epoxy compound. Satisfying the above-mentioned numerical range has an advantage of effectively curing the composition during photocuring.

According to one embodiment of the present specification, the glycidyl ether-type epoxy compound is preferably included in 10 parts by weight to 60 parts by weight and more preferably in 30 parts by weight to 50 parts by weight based on a total weight of the epoxy compound.

In one embodiment of the present specification, the oxetane compound is a compound having 4-membered ring ether in the molecule, and examples thereof may comprise 3-ethyl-3-hydroxymethyloxetane, 1,4-bis[(3-ethyl-3-oxetanyl)methoxymethyl]benzene, 3-ethyl-3-(phenoxymethyl)oxetane, di[(3-ethyl-3-oxetanyl)methyl]ether, 3-ethyl-3-(2-ethylhexyloxymethyl)oxetane, phenol novolac oxetane and the like, but are not limited thereto. These oxetane compounds may be readily obtained as commercial products, and specific examples thereof may comprise ARON OXETANE OXT-101 (manufactured by TOAGOSEI Co., Ltd.), ARON OXETANE OXT-121 (manufactured by TOAGOSEI Co., Ltd.), ARON OXETANE OXT-211 (manufactured by TOAGOSEI Co., Ltd.), ARON OXETANE OXT-221 (manufactured by TOAGOSEI Co., Ltd.), ARON OXETANE OXT-212 (manufactured by TOAGOSEI Co., Ltd.) and the like.

According to one embodiment of the present specification, the epoxy compound is preferably included in 10 parts by weight to 50 parts by weight and more preferably included in 15 parts by weight to 40 parts by weight with respect to a total 100 parts by weight of the adhesive composition.

According to one embodiment of the present specification, the oxetane compound is preferably included in 10 parts by weight to 50 parts by weight and more preferably included in 15 parts by weight to 40 parts by weight with respect to a total 100 parts by weight of the adhesive composition.

According to one embodiment of the present specification, the adhesive composition may further comprise a photocation polymerization initiator or a radical initiator. Types of the photocation polymerization initiator or the radical initiator may be selected from among the examples of the photocation polymerization initiator and the radical initiator in the composition for a polarizing plate protective layer described above.

In addition, the adhesive composition of the present specification may further comprise a photosensitizer.

Examples of the photosensitizer may comprise carbonyl compounds, organosulfur compounds, persulfides, redox-based compounds, azo and diazo compounds, anthracene-based compounds, halogen compounds, photoreductive dyes and the like, but are not limited thereto.

In addition, the adhesive composition of the present specification may further comprise a silane coupling agent. When comprising a silane coupling agent, the silane coupling agent lowers surface energy of the adhesive obtaining an effect of enhancing adhesive wetting.

Herein, the silane coupling agent more preferably comprises a cation polymerizable functional group such as an epoxy group, a vinyl group or a radical group. In addition, using a silane coupling agent that does not comprise a cation polymerizable functional group is effective in improving wetting without lowering a glass transition temperature compared to a silane coupling agent that does not comprise a surfactant or a cation polymerizable functional group. This is due to the fact that the cation polymerization functional group of the silane coupling agent reduces a phenomenon of lowering a glass transition temperature of an adhesive layer after curing by forming a crosslinked form while reacting with a silane group of the adhesive composition.

Meanwhile, the adhesive layer may be formed using methods well known in the art. For example, an adhesive composition is coated on one surface of a polarizer or a protective film to form an adhesive layer, laminating the polarizer and the protective film, and then curing the result. Herein, the coating may be performed using coating methods well known in the art such as methods of spin coating, bar coating, roll coating, gravure coating or blade coating. In addition, after coating the adhesive composition, a separate drying process may be further included before the curing. The drying method is not limited as long as it is a method commonly used in the art.

One embodiment of the present specification provides an image display device comprising the polarizing plate.

In the present specification, the image display device may be a liquid crystal display device (LCD), a plasma display device (PDP) and an organic electroluminescent display device (OLED).

More specifically, the image display device may be a liquid crystal display comprising a liquid crystal panel and polarizing plates each provided on both surfaces of the liquid crystal panel, and herein, at least one of the polarizing plates may be the polarizing plate comprising the polarizer according to one embodiment of the present specification described above. In other words, the polarizing plate locally has, in a polarizing plate comprising a polyvinyl alcohol-based polarizer dye with iodine and/or a dichroic dye and a protective film provided on at least one surface of the polyvinyl alcohol-based polarizer, a depolarized area with single body transmittance of 80% or greater in a wavelength band of 400 nm to 800 nm, and the depolarized area has arithmetic mean roughness (Ra) of 200 nm or less, a polarization degree of 10% or less and sagging of 10 μm or less.

Herein, types of the liquid crystal panel included in the liquid crystal display device are not particularly limited. For example, passive matrix-type panels such as a twisted nematic (TN)-type, a super twisted nematic (STN)-type, a ferroelectric (F)-type or a polymer dispersed (PD)-type; active matrix-type panels such as a two terminal-type or a three terminal-type; in plane switching (IPS)-type panels and vertical alignment (VA)-type panels may be included, however, the liquid crystal panel is not limited thereto. In addition, types of other constitutions forming the liquid crystal display device such as upper and lower substrates (for example, color filter substrate or array substrate) are not particularly limited as well.

Hereinafter, the present specification will be described in detail with reference to examples in order to specifically describe the present specification. However, examples according to the present specification may be modified to various other forms, and the scope of the present specification may not be construed as being limited to the examples described below. The examples of the present specification are provided in order to more fully describe the present specification to those having average knowledge in the art.

### EXPERIMENTAL EXAMPLE—PREPARATION OF PHOTOCURABLE COMPOSITION FOR POLARIZING PLATE PROTECTIVE LAYER

### Experimental Example 1—Preparation of Photocurable Composition 1

Photocurable Composition 1 was prepared using 65 parts by weight of 3,4-epoxycyclohexylmethyl-3′,4′-epoxycyclohexane carboxylate (product name Celloxide-2021), 15 parts by weight of 3-ethyl-3-[(3-ethyloxetan-3-yl)methoxymethyl]oxetane (TOAGOSEI Co., Ltd. ARON OXETANE OXT-221) and 20 parts by weight of 1,4-cyclohexyl dimethanol diglycidyl ether (CHDMDGE), and adding 2.64 parts by weight of Irgacure 250 as a photoinitiator, 0.1 parts by weight of uvs-1331 as a photosensitizer and 2 parts by weight of ET-2201 as an auxiliary photosensitizer thereto.

### Experimental Example 2—Preparation of Photocurable Composition 2

Photocurable Composition 2 was prepared using 65 parts by weight of 3,4-epoxycyclohexylmethyl-3′,4′-epoxycyclohexane carboxylate (product name Celloxide-2021), 15 parts by weight of 3-ethyl-3-[(3-ethyloxetan-3-yl)methoxymethyl]oxetane (TOAGOSEI Co., Ltd. ARON OXETANE OXT-221) and 20 parts by weight of 1,4-cyclohexyl dimethanol diglycidyl ether (CHDMDGE), and adding 2.64 parts by weight of Irgacure 250 as a photoinitiator, 0.1 parts by weight of uvs-1331 as a photosensitizer and 1 parts by weight of ET-2201 as an auxiliary photosensitizer thereto.

### Experimental Example 3—Preparation of Photocurable Composition 3

Photocurable Composition 3 was prepared using 65 parts by weight of 3,4-epoxycyclohexylmethyl-3′,4′-epoxycyclohexane carboxylate (product name Celloxide-2021), 15 parts by weight of 3-ethyl-3-[(3-ethyloxetan-3-yl)methoxymethyl]oxetane (TOAGOSEI Co., Ltd. ARON OXETANE OXT-221) and 20 parts by weight of 1,4-cyclohexyl dimethanol diglycidyl ether (CHDMDGE), and adding 2.64 parts by weight of Irgacure 250 as a photoinitiator and 1.05 parts by weight of ESACURE ITX as a photosensitizer thereto.

### Experimental Example 4—Preparation of Photocurable Composition 4

Photocurable Composition 4 was prepared using 65 parts by weight of 3,4-epoxycyclohexylmethyl-3′,4′-epoxycyclohexane carboxylate (product name Celloxide-2021), 15 parts by weight of 3-ethyl-3-[(3-ethyloxetan-3-yl)methoxymethyl]oxetane (TOAGOSEI Co., Ltd. ARON OXETANE OXT-221) and 20 parts by weight of 1,4-cyclohexyl dimethanol diglycidyl ether (CHDMDGE), and adding 3.96 parts by weight of CPI-100P as a photoinitiator, 0.1 parts by weight of uvs-1331 as a photosensitizer and 2 parts by weight of ET-2201 as an auxiliary photosensitizer thereto.

### Experimental Example 5—Preparation of Photocurable Composition 5

Photocurable Composition 5 was prepared using 65 parts by weight of 3,4-epoxycyclohexylmethyl-3′,4′-epoxycyclohexane carboxylate (product name Celloxide-2021), 15 parts by weight of 3-ethyl-3-[(3-ethyloxetan-3-yl)methoxymethyl]oxetane (TOAGOSEI Co., Ltd. ARON OXETANE OXT-221) and 20 parts by weight of 1,4-cyclohexyl dimethanol diglycidyl ether (CHDMDGE), and adding 3.96 parts by weight of CPI-100P as a photoinitiator and 1.05 parts by weight of uvs-1331 as a photosensitizer thereto.

Photocurable compositions 1 to 5 may be summarized as in the following Table 1.

TABLE 1

| | | | Auxiliary |
|---|---|---|---|
| Category | Photoinitiator | Photosensitizer | Photosensitizer |
| Photocurable | Iodine-based | Anthracene- | Naphthalene- |
| Composition | Photoinitiator | based Compound | based Compound |
| 1 | (Irgacure 250) | (uvs-1331) | (ET-2201) |
| Photocurable | Iodine-based | Anthracene- | Naphthalene- |
| Composition | Photoinitiator | based Compound | based Compound |
| 2 | (Irgacure 250) | (uvs-1331) | (ET-2201) |
| Photocurable | Iodine-based | Non-anthracene- | — |
| Composition | Photoinitiator | based Compound | |
| 3 | (Irgacure 250) | (ESACURE ITX) | |
| Photocurable | Sulfur-based | Anthracene- | Naphthalene- |
| Composition | Photoinitiator | based Compound | based Compound |
| 4 | (CPI-100P) | (uvs-1331) | (ET-2201) |
| Photocurable | Sulfur-based | Anthracene- | — |
| Composition | Photoinitiator | based Compound | |
| 5 | (CPI-100P) | (uvs-1331) | |

Structures of the photoinitiator, the photosensitizer and the auxiliary photosensitizer are as in the following Table 2.

TABLE 2

| Category | Name and Structure | |
|---|---|---|
| Photoinitiator | Iodine-based | Sulfur-based |
| | Photoinitiator | Photoinitiator |
| | [Irgacure 250] | [CPI-100P] |
| | 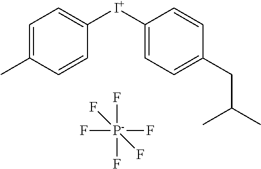 [SMILES: Cc1ccc([I+]c2ccc(CC(C)C)cc2)cc1 ; F[P-](F)(F)(F)(F)F] | 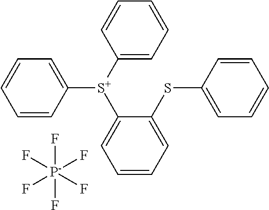 [SMILES: c1ccc(Sc2ccccc2[S+](c2ccccc2)c2ccccc2)cc1 ; F[P-](F)(F)(F)(F)F] |
| Photosensitizer | Anthracene-based | Non-anthracene-based |
| | Compound | Compound |
| | [uvs-1331] | [ESCURE ITX] |
| | 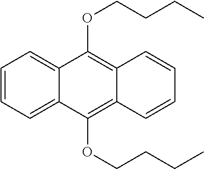 [SMILES: CCCCOc1c2ccccc2c(OCCCC)c2ccccc12] | 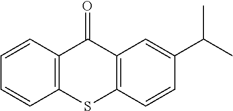 [SMILES: CC(C)c1ccc2sc3ccccc3c(=O)c2c1] |

| | |
|---|---|
| Auxiliary | Naphthalene-based Compound |
| Photosensitizer | [ET-2201] |
| | 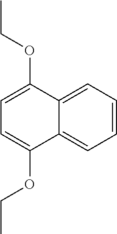 [SMILES: CCOc1ccc(OCC)c2ccccc12] |

Photocurable Compositions 1 and 2 comprise a photoinitiator of an iodine-based compound, a photosensitizer of an anthracene-based compound, and an auxiliary photosensitizer of a naphthalene-based compound. Meanwhile, Composition 3 comprises a photosensitizer of a non-anthracene-based compound, and does not comprise a separate auxiliary photosensitizer. Composition 4 comprises a sulfur-based photoinitiator instead of a photoinitiator of an iodine-based compound, and Composition 5 comprises a sulfur-based photoinitiator instead of a photoinitiator of an iodine-based compound, and does not comprise an auxiliary photosensitizer.

### Experimental Example 6—Preparation of Adhesive Composition A

Adhesive Composition A was prepared using 30 parts by weight of 3,4-epoxycyclohexylmethyl-3′,4′-epoxycyclohexane carboxylate(product name Celloxide-2021P), 15 parts by weight of 3-ethyl-3-[(3-ethyloxetan-3-yl)methoxymethyl]oxetane (TOAGOSEI Co., Ltd. ARON OXETANE OXT-221), 45 parts by weight of 1,4-cyclohexyl dimethanol diglycidyl ether (CHDMDGE) (product name LD-204) and 10 parts by weight of nonanediol diacrylate (product name A-NOD-N), and adding 3 parts by weight of IRGACURE 250 as a photoinitiator and 1 parts by weight of ESACURE ITX as a photosensitizer thereto.

### Experimental Example 7—Preparation of Adhesive Composition B

Adhesive Composition B was prepared using 30 parts by weight of 3,4-epoxycyclohexylmethyl-3′,4′-epoxycyclohexane carboxylate(product name Celloxide-2021P), 15 parts by weight of 3-ethyl-3-[(3-ethyloxetan-3-yl)methoxymethyl]oxetane (TOAGOSEI Co., Ltd. ARON OXETANE OXT-221), 45 parts by weight of 1,4-cyclohexyl dimethanol diglycidyl ether (CHDMDGE) (product name LD-204) and 10 parts by weight of nonanediol diacrylate (product name A-NOD-N), and adding 5 parts by weight of diphenyl-(4-phenylthio)phenylsulfonium hexafluorophosphate (CPI100P, manufactured by Sanapro) as a photoinitiator thereto.

### Example 1—Manufacture of Polarizing Plate (Protective Film/Adhesive Layer/PVA/Protective Layer)

### Example 1-1

### (1) Preparation of Laminate (Protective Film/Adhesive Layer/PVA)

A polarizer was prepared using a method of dyeing a polyvinyl alcohol (PVA)-based resin film with a dichroic dye, then elongating the result in a certain direction and crosslinking the result. On one surface of the prepared polarizer, Adhesive Composition A was coated using a roll coater to form an adhesive layer, and after laminating a PET film (TA-044, manufactured by Toyobo Co., Ltd.) thereon as a protective film, the polarizer and protective film were adhered to each other through curing by irradiating ultraviolet rays of 1,000 mJ/cm² using an ultraviolet irradiator. The adhesive layer had a thickness of 2 μm.

### (2) Manufacture of Polarizing Plate

On a surface opposite to the protective film-laminated surface of the polarizer, Photocurable Composition 1 was coated using a bar coater or a roll coater, and a protective layer having a thickness of 6.5 μm was formed by irradiating ultraviolet rays of 1,000 mJ/cm² using an ultraviolet irradiator to manufacture a polarizing plate. The polarizing plate has a structure in which a protective film is laminated on one surface of a polarizer using an adhesive layer as a medium, and a protective layer is directly formed on a surface opposite to the protective film-laminated surface of the polarizer.

### Example 1-2

A polarizing plate was manufactured in the same manner as in Example 1-1 except that Photocurable Composition 2 was used instead of Photocurable Composition 1.

### Comparative Examples 1-1 to 1-3

Polarizing plates were manufactured in the same manner as in Example 1-1 except that Photocurable compositions 3 to 5 were respectively used instead of Photocurable Composition 1.

### Evaluation Example 1

### Evaluation Example 1-1—Evaluation on High Temperature Facilitation (Evaluation on Rate of Crack Occurrences)

Using each of the photocurable compositions prepared in Experimental Examples 1 to 5, a laminate was prepared in the same manner as in Example 1-1. After that, a polarizing plate was manufactured in the same manner as in Example 1-1, Example 1-2 and Comparative Examples 1-1 to 1-4 except that cracks were induced on the polarizer by scraping with a load of 300 g using a blunt pencil.

After cutting the polarizing plate to a width of 120 mm and a length of 100 mm, the polarizing plate was left unattended for 100 hours to 300 hours at 80° C., and it was observed whether light leaked by the opening of cracks due to polarizer shrinkage. The number of cracks having light leakage among the total cracks was calculated to derive a rate of crack occurrences in the polarizing plate, and the results are shown in the following Table 3.

*Rate of crack occurrences: (number of cracks having light leakage/number of total cracks)×100 (%)

### Evaluation Example 1-2—Evaluation on Yellowing Scale Value (b)

A protective layer having a thickness of 6 μm was formed by coating each of the photocurable compositions prepared in Experimental Examples 1 to 5 on a TAC film (manufactured by Fuji Corporation, thickness 25 μm) using a bar coater or a roll coater, and then irradiating ultraviolet rays of 1,000 mJ/cm² using an ultraviolet irradiator, and an evaluation on a yellowing scale value (b) was performed. Herein, the yellowing scale value (b) was obtained using a spectrophotometer (V-7100, manufactured by JASCO International Co., Ltd.), and for accuracy, the measurement was made 3 times, and an increase rate between the average value and an initial value (S) was calculated using the following Equation 1. The results are shown in the following Table 3. The experiment was performed under a condition of a temperature of 25° C. and relative humidity (RH) of 40%.

Increase rate of yellowing scale value (b)=yellowing scale value (b) of protective layer coated on polarizer−initial value (S, yellowing scale value (b) of polarizer without protective layer) [Equation 1]

### Evaluation Example 1-3—Evaluation on Storage Modulus of Protective Layer

Photocurable Composition 1 prepared in Experimental Example 1 and Adhesive Composition B prepared in Experimental Example 8 were each coated on a release film (polyethylene terephthalate film, RPK38-401, manufactured by Toray Advanced Materials) to a thickness of 50 μm, and after curing the result by irradiating ultraviolet rays under a condition of light intensity being 1000 mJ/cm² or greater, the release film was removed, and the specimen was cut to a width of 5.3 mm and a length of 4.5 cm using a laser. After that, storage modulus of the protective layer was measured using a dynamic mechanical analyzer (DMA). With a measurement mode of multi-frequency-strain, the storage modulus was measured at strain 10% and frequency 1 Hz while raising a temperature up to 160° C. from −30° C. at a temperature raising rate of 5° C. per 1 minute, and the results are shown in the following Table 3. For the rest of the compositions, storage modulus was measured in the same manner.

TABLE 3

| | | | | | | Evaluation | |
|---|---|---|---|---|---|---|---|
| | | | | | | on High | |
| | | | | | Increase | Temperature | |
| | | b Value of | | | Rate | Facilitation | |
| | | Protective | | | of | (Rate of | Storage |
| | | Layer Coated on | | | Average | Crack | Modulus |
| | Photocurable | TAC Film | | | b | Occurrences, | (MPa, |
| Category | Composition | First | Second | Third | Value | %) | @80° C.) |
| Ref. | None | 0.09 | 0.10 | 0.09 | — | — | — |
| (TAC | | | | | | | |
| Film) | | | | | | | |
| Example | Composition | 0.26 | 0.24 | 0.23 | 0.150 | 0% | 1,892 |
| 1-1 | 1 | | | | | | |
| Example | Composition | 0.26 | 0.24 | 0.25 | 0.156 | 0% | 1,857 |
| 1-2 | 2 | | | | | | |
| Comparative | Composition | 0.59 | 0.61 | 0.61 | 0.513 | 0% | 1,885 |
| Example | 3 | | | | | | |
| 1-1 | | | | | | | |
| Comparative | Composition | 0.35 | 0.31 | 0.32 | 0.229 | 60% | 1,650 |
| Example | 4 | | | | | | |
| 1-2 | | | | | | | |
| Comparative | Composition | 1.05 | 1.12 | 1.08 | 0.988 | 40% | 1,680 |
| Example | 5 | | | | | | |
| 1-3 | | | | | | | |

As shown in Table 3, it was seen that Examples 1-1 and 1-2 using the photocurable composition for a polarizing plate protective layer of the present specification were very effective in preventing crack occurrences as well as in preventing a yellowing phenomenon. Specifically, it was seen that the protective layer, the cured material of the photocurable composition for a polarizing plate protective layer of the present specification, was very effective in preventing a yellowing phenomenon compared to Comparative Example 1-1 to 1-3 with a yellowing scale value (b) increase rate of 0.3 or less. In addition, the rate of crack occurrences was also measured as 0%, and it was seen that Examples 1-1 and 1-2 were very effective in preventing crack occurrences as well as in preventing a yellowing phenomenon.

When referring to Table 3, it can be identified that, even when a storage modulus range of each composition is similar, the rate of crack occurrences may be adjusted to near 0% while the average b value increase rate significantly changes when changing composition types such as a photoinitiator of each composition.

Accordingly, an average b value increase rate is not similar just by having a similar storage modulus range, and by using specific types of a photoinitiator and the like, the average b value increase rate may be maintained to be small, and the rate of crack occurrences may also be adjusted to near 0%.

In summary, by comprising specific types of a photoinitiator, a photosensitizer and an auxiliary photosensitizer in the protective layer composition, a yellowing phenomenon of the protective layer was able to be suppressed, and high temperature durability was able to be suppressed.

### Example 2—Manufacture of Polarizing Plate

### Examples 2-1 to 2-4—Protective Film/Adhesive Layer/PVA/Protective Layer

Polarizing plates were manufactured in the same manner as in Example 1-1 except for varying the protective layer composition and the protective layer thickness as in the following Table 4.

### Comparative Example 2-1—Protective Film/Adhesive Layer/PVA/Adhesive Layer/Protective Film A

Adhesive Composition A was coated on one surface of the same polarizer as that used in Examples 2-1 to 2-3 to a thickness of 2 μm using a roll coater, and a corona treated polyethylene terephthalate film (TA-044, manufactured by Toyobo Co., Ltd.) having a thickness of 80 μm was laminated thereon. On a surface opposite to the Adhesive Composition A-coated surface of the polarizer, Adhesive Composition B was coated to a thickness of 1 μm using a roll coater, and after laminating a TAC film (manufactured by Fuji Corporation) having a thickness of 25 μm as Protective Film A, photocurable Adhesive compositions A and B were cured by irradiating ultraviolet rays to manufacture a polarizing plate.

### Comparative Example 2-2—Protective Film/Adhesive Layer/PVA/Adhesive Layer/Protective Film A

A polarizing plate was manufactured in the same manner as in Comparative Example 2-1 except that an acrylic film manufactured by Riken was used as Protective Film A and Protective Film A was formed to a thickness of 40 μm.

### Comparative Example 2-3—Protective Film/Adhesive Layer/PVA/Adhesive Layer/Protective Film A

A polarizing plate was manufactured in the same manner as in Comparative Example 2-1 except that an acrylic film manufactured by LGC was used as Protective Film A and Protective Film A was formed to a thickness of 40 μm.

### Evaluation Example 2

### Evaluation Example 2-1—Evaluation on High Temperature Facilitation (Evaluation on Rate of Crack Occurrences)

For each of the polarizing plates manufactured in Examples 2-1 to 2-3 and Comparative Examples 2-1 to 2-3, an evaluation on high temperature facilitation was performed. Cracks were induced on the polarizer by scraping with a load of 300 g using a blunt pencil. After that, the polarizing plate was cut to a width of 120 mm and a length of 100 mm, left unattended for 100 hours at 80° C., and it was observed whether light leaked by the opening of cracks due to polarizer shrinkage. The number of cracks having light leakage among the total cracks was calculated to derive a rate of crack occurrences in the polarizing plate, and the results are shown in the following Table 4.

*Rate of crack occurrences: (number of cracks having light leakage/number of total cracks)×100 (%)

### Evaluation Example 2-2—Evaluation on Storage Modulus

Photocurable Composition 1 prepared in Experimental Example 1 and Adhesive Composition B prepared in Experimental Example 8 were each coated on a release film (polyethylene terephthalate film, RPK38-401, manufactured by Toray Advanced Materials) to a thickness of 50 μm, and after curing the result by irradiating ultraviolet rays under a condition of light intensity being 1000 mJ/cm² or greater, the release film was removed, and the specimen was cut to a width of 5.3 mm and a length of 4.5 cm using a laser. After that, storage modulus was measured using a dynamic mechanical analyzer (DMA). With a measurement mode of multi-frequency-strain, the storage modulus was measured at strain 10% and frequency 1 Hz while raising a temperature up to 160° C. from −30° C. at a temperature raising rate of 5° C. per 1 minute, and the results are shown in the following Table 4.

In addition, for each of Protective Films A used in Comparative Examples 2-1 to 2-3, storage modulus was measured using a dynamic mechanical analyzer (DMA). With a measurement mode of multi-frequency-strain, the storage modulus was measured at strain 10% and frequency 1 Hz while raising a temperature up to 160° C. from −30° C. at a temperature raising rate of 5° C. per 1 minute, and the results are shown in the following Table 4.

TABLE 4

| | | | | | Evaluation |
|---|---|---|---|---|---|
| | | | | | on High |
| | | | | | Temperature |
| | | | Protective | Storage | Facilitation |
| | | Protective | Layer | Modulus | (Rate of Crack |
| | | Layer | Thickness | (80° C., | Occurrences, |
| Category | | Composition | (μm) | MPa) | %) |
| Example | Protective | Photocurable | 5 | 1900 | 20% |
| 2-1 | Layer | Composition 1 | | | |
| Example | Protective | Photocurable | 8 | 1900 | 0% |
| 2-2 | Layer | Composition 1 | | | |
| Example | Protective | Photocurable | 10 | 1900 | 0% |
| 2-3 | Layer | Composition 1 | | | |
| Com- | Protective | TAC Film | 25 | 2800 | 80% |
| parative | Film A | of Fuji | | | |
| Example | | Corporation | | | |
| 2-1 | Adhesive | Adhesive | 1 | 700 | |
| | Layer | Composition B | | | |
| Com- | Protective | Acrylic Film | 40 | 1800 | 100% |
| parative | Film A | of Riken | | | |
| Example | Adhesive | Adhesive | 1 | 700 | |
| 2-2 | Layer | Composition B | | | |
| Com- | Protective | Acrylic Film | 40 | 1900 | 100% |
| parative | Film A | of LGC | | | |
| Example | Adhesive | Adhesive | 1 | 700 | |
| 2-3 | Layer | Composition B | | | |

As shown in Table 4, it was seen that Examples 2-1 to 2-3 using the photocurable composition for a polarizing plate protective layer of the present specification had excellent storage modulus as well as being very effective in preventing crack occurrences. Specifically, it was seen that Examples 2-1 to 2-3 directly forming a protective layer on a polarizer had a lower rate of crack occurrences compared to Comparative Examples 2-1 to 2-3 forming with an adhesive layer and Protective Film A. In addition, although the thickness of Protective Film A of the polarizing plate according to Comparative Examples 2-1 to 2-3 was from 25 μm to 40 μm, which was thicker than 5 μm to 10 μm, a thickness of the protective layer of Examples 2-1 to 2-3, a number of cracks occurred decreasing durability.

In addition, the polarizing plate according to Examples 2-1 to 2-3 had a protective layer directly formed on a polarizer, and storage modulus the protective layer was high of 1,500 MPa or greater without comprising a separate protective film. Accordingly, it was seen that the protective layer according to one embodiment of the present specification effectively suppressed a shrinkage or expansion phenomenon of the polarizer at a high temperature without a separate protective film.

On the other hand, in the polarizing plate according to Comparative Examples 2-1 to 2-3, storage modulus of the adhesive layer formed on the polarizer was low even when storage modulus of Protective Film A was high. Accordingly, a shrinkage or expansion phenomenon of the polarizer at a high temperature was not able to be effectively suppressed.

It was identified that, when manufacturing a polarizing plate using Composition 1 or 2 as a protective layer, the rate of crack occurrences was 0% in the evaluation on high temperature facilitation while an average b value increase rate was 0.16 or less by suppressing a yellowing phenomenon. This is due to that fact that the above-described specific types were used as the photoinitiator, the photosensitizer and the auxiliary photosensitizer.

On the other hand, it was identified that, when changing the type of the photoinitiator to a sulfur-based photoinitiator instead of the iodine-based photoinitiator (Comparative Example 1-2 and Comparative Example 1-3), using a different type of compound instead of the anthracene-based compound as the type of the photosensitizer (Comparative Example 1-1), or not comprising the auxiliary photosensitizer (Comparative Example 1-1, Comparative Example 1-3), an average b value increase rate was high of 0.5 or higher, or the rate of high temperature crack occurrences was 40% or greater, which means being very vulnerable at a high temperature environment.

Hereinbefore, preferred embodiments of the present specification have been described, however, the present disclosure is not limited thereto, and various modifications may be made within the scope of the claims and the detailed descriptions of the disclosure, and these also fall within the category of the disclosure.

1. A polarizing plate comprising:
a polarizer; and
a protective layer in contact with at least one surface of the polarizer,
wherein the protective layer is a cured material of a photocurable composition for a polarizing plate protective layer comprising a photopolymerizable compound; a photoinitiator; a photosensitizer; and an auxiliary photosensitizer, wherein the photopolymerizable compound consists of a first epoxy-based compound, a second epoxy-based compound and an oxetane compound;
the protective layer has storage modulus of 1,500 MPa to 10,000 MPa at 80° C.;
the protective layer has a thickness of 5 μm to 10 μm; and
a yellowing scale value (b) of the protective layer measured by the following Equation 1 has an increase rate of 0.05 to 0.3 compared to an initial value (S) under a condition of a temperature of 25° C. and relative humidity (RH) of 40%:
increase rate of yellowing scale value (b)=yellowing scale value (b) of protective layer coated on polarizer−initial value (S, yellowing scale value (b) of polarizer without protective layer). [Equation 1]

2. The polarizing plate of claim 1, wherein the protective layer is formed on the polarizer by coating.

3. The polarizing plate of claim 1, wherein the first epoxy-based compound is an alicyclic epoxy-based compound.

4. The polarizing plate of claim 1, wherein the second epoxy-based compound is an aliphatic epoxy-based compound.

5. The polarizing plate of claim 1, wherein the first epoxy-based compound is included in 50 parts by weight to 70 parts by weight with respect to a total 100 parts by weight of the photopolymerizable compound.

6. The polarizing plate of claim 1, wherein the second epoxy-based compound is included in 10 parts by weight to 20 parts by weight with respect to a total 100 parts by weight of the photopolymerizable compound.

7. The polarizing plate of claim 1, wherein the oxetane compound is included in 10 parts by weight to 30 parts by weight with respect to a total 100 parts by weight of the photopolymerizable compound.

8. The polarizing plate of claim 1, wherein the photoinitiator is an iodine-based compound absorbing a wavelength of 310 nm or lower.

9. The polarizing plate of claim 1, wherein the photosensitizer is an anthracene-based compound absorbing a wavelength of 380 nm or higher.

10. The polarizing plate of claim 1, wherein the auxiliary photosensitizer is a naphthalene-based compound.

11. The polarizing plate of claim 1, wherein the photoinitiator is included in 2 parts by weight to 5 parts by weight with respect to a total 100 parts by weight of the photocurable composition for a polarizing plate protective layer.

12. The polarizing plate of claim 1, wherein the photosensitizer is included in 0.1 parts by weight to 0.5 parts by weight with respect to a total 100 parts by weight of the photocurable composition for a polarizing plate protective layer.

13. The polarizing plate of claim 1, wherein the auxiliary photosensitizer is included in 1 parts by weight to 3 parts by weight with respect to a total 100 parts by weight of the photocurable composition for a polarizing plate protective layer.

14. The polarizing plate of claim 1, wherein the photocurable composition for a polarizing plate protective layer has viscosity of greater than or equal to 50 cps and less than or equal to 200 cps at 25° C.

15. The polarizing plate of claim 1, wherein a protective film is attached on a surface opposite to the at least one surface in contact with the protective layer of the polarizer using an adhesive layer.

16. The polarizing plate of claim 15, wherein the adhesive layer is a cured material of an adhesive composition, and the adhesive composition comprises an epoxy compound and an oxetane compound.

17. An image display device comprising the polarizing plate of claim 1.
